(19) United States
(12) Patent Application Publication
(10) Pub. No.: US 2015/0120304 A1
(43) Pub. Date: Apr. 30, 2015

(54) SPEAKING CONTROL METHOD, SERVER, SPEAKING DEVICE, SPEAKING SYSTEM, AND STORAGE MEDIUM

(71) Applicant: SHARP KABUSHIKI KAISHA, Osaka-shi (JP)

(72) Inventors: Yasunori YAMASHITA, Osaka-shi (JP); Masafumi HIRATA, Osaka-shi (JP); Hideaki KIZUKI, Osaka-shi (JP); Makoto SHINKAI, Osaka-shi (JP)

(73) Assignee: SHARP KABUSHIKI KAISHA, Osaka-shi (JP)

(21) Appl. No.: 14/527,117

(22) Filed: Oct. 29, 2014

(30) Foreign Application Priority Data
Oct. 31, 2013 (JP) 2013-227569
Oct. 17, 2014 (JP) 2014-212602

(51) Int. Cl. G10L 17/22; G10L 15/00

(52) U.S. Cl. CPC G10L 17/22; G10L 15/00
USPC 704/270.1

(57) ABSTRACT

A speaking control method including a switching step of switching between answer options for an answer to a user in a case where a sound level of target audio data falls within a first predetermined sound-level range, the answer options being associated with a case where audio data content indicated by the target audio data is recognized and a case where the audio data content is not recognized, respectively.

This Nonprovisional application claims priority under 35 U.S.C. §119 on Patent Application No. 2013-227569 filed in Japan on Oct. 31, 2013 and on Patent Application No. 2014-212602 filed in Japan on Oct. 17, 2014, the entire contents of which are hereby incorporated by reference.

### TECHNICAL FIELD

The present invention relates to a speaking control method, a server, a speaking device, a speaking system, and a computer-readable storage medium storing a program, all of which provide virtual communication.

### BACKGROUND ART

There is a simulated conversation system known to carry out a simulated conversation with a user by outputting a reply to a word(s) inputted by the user. Patent Literature 1 discloses such a simulated conversation system employing a technology that (i) updates and stores a conversation history of a simulated conversation, which conversation history contains accumulated values of evaluations of words inputted by a user and (ii), in a case where the accumulated values of the evaluations meet a conversation changing condition, outputs a reply which discusses a subject different from a subject of a simulated conversation being carried out. In a case where the word inputted by a user is unrecognizable or where there is no reply corresponding to the word, the simulated conversation system carries on the simulated conversation by outputting a reply in view of the conversation history.

### CITATION LIST

### Patent Literature

Patent Literature 1
Japanese Patent Application Publication, Tokukai, No. 2002-169804 (Publication Date: Jun. 14, 2002)

### SUMMARY OF INVENTION

### Technical Problem

Meanwhile, apart from the simulated conversation system, there has been extensive research conducted on a speaking system which involves a home electrical appliance capable of connecting to a network and which realizes virtual communication with a user of the home electrical appliance. Such a speaking system normally includes: a server for controlling an operation of an entire speaking system; and a speaking device (home electrical appliance). The speaking device transmits a question (voice input) of a user to the server. The server recognizes the voice data and replies with corresponding answer data. Then, the speaking device verbally outputs the answer data to the user.

In such a speaking system, there is a possibility that a speaking device obtains, as audio data in addition to a voice inputted by a user into the speaking device, various sounds that are generated in the vicinity of the speaking device such as everyday conversations, sounds of pets, and sounds generated by a television. In such a case, a problem arises that a server incorrectly recognizes sounds and proceeds to unexpectedly outputs answer data even without a user's voice input (without the user's questioning).

The present invention has been made in view of the problem, and it is an object of the present invention to realize a server that facilitates proper voice communication.

### Solution to Problem

In order to attain the object, a speaking control method in accordance with one aspect of the present invention includes: a switching step of switching between answer options for an answer to a user in a case where a sound level of target audio data falls within a first predetermined sound-level range, the answer options being associated with a case where audio data content indicated by the target audio data is recognized and a case where the audio data content is not recognized, respectively.

In order to attain the object, a server in accordance with one aspect of the present invention includes: an answer option switching section switches between answer options for an answer to a user in a case where a sound level of target audio data falls within a first predetermined sound-level range, the answer options being associated with a case where audio data content indicated by the target audio data is recognized and a case where the audio data content is not recognized, respectively.

In order to attain the object, a speaking device in accordance with one aspect of the present invention includes: a voice data extracting section configured to extract, from audio data obtained, voice data containing only a frequency band of a human voice; a sound level determining section configured to determine a sound level of the voice data; a voice recognizing section configured to recognize, in a case where the sound level thus determined by the sound level determining section falls within a predetermined sound-level range, voice data content as recognition content, which voice data content is indicated by the voice data; an answer option switching section configured to (i) switch between answer options for an answer to a user, the answer options being associated with a case where voice data content indicated by the voice data is recognized and a case where the voice data content is not recognized, respectively and (ii) determine answer content; and an answer outputting section configured to output a voice indicative of the answer content thus determined by the answer option switching section.

In order to attain the object, a speaking system in accordance with one aspect of the present invention includes: a speaking device; and a server, said speaking device including a voice data extracting section configured to extract, from audio data obtained, voice data containing only a frequency band of a human voice, a voice data transmitting section configured to transmit the voice data, an answer data receiving section configured to receive answer data with respect to the voice data, and an answer outputting section configured to output, in a case where the answer data receiving section receives the answer data, a voice indicated by the answer data, said server including a voice data receiving section configured to receive the voice data from the speaking device, a sound level determining section configured to determine a sound level of the voice data thus received by the voice data receiving section, an answer option switching section configured to (i) switch between answer options for an answer to a user in a case where the sound level of the voice data thus determined falls within a predetermined sound-level range, the answer options being associated with a case where voice data content indicated by the voice data is recognized and a case where the voice data content is not recognized, respectively and (ii) determine answer content, and an answer transmitting section configured to transmit answer data indicative of the answer content thus determined by the answer option switching section.

In order to attain the object, a speaking device in accordance with one aspect of the present invention includes: a voice data extracting section configured to extract, from audio data obtained, voice data containing only a frequency band of a human voice; a voice data transmitting section configured to transmit the voice data; an answer data receiving section configured to receive answer data with respect to the voice data; and an answer outputting section configured to output, in a case where the answer data receiving section receives the answer data, a voice indicated by the answer data, the answer data being answer data indicative of answer content determined by switching between answer options for an answer to a user in a case where a sound level of the voice data transmitted by the voice data transmitting section falls within a predetermined sound-level range, the answer options being associated with a case where voice data content indicated by the voice data is recognized and a case where the voice data content is not recognized, respectively.

### Advantageous Effects of Invention

With an aspect of the present invention, it is possible to prevent a reply from being made with an inappropriate timing, and therefore to realize more appropriate conversational communication.

### BRIEF DESCRIPTION OF DRAWINGS

FIG. 1 is a block diagram illustrating a main configuration of a speaking system in accordance with Embodiment 1 of the present invention.

FIG. 2 is an external view showing an overview of the speaking system in accordance with Embodiment 1 of the present invention.

FIG. 3 is a sequence diagram illustrating a flow of a replying voice output process of the speaking system in accordance with Embodiment 1 of the present invention.

FIG. 4 is a view illustrating a reply option table stored in a storage section of a server in accordance with Embodiment 1 of the present invention.

FIG. 5 is a view illustrating a normal reply database stored in the storage section of the server in accordance with Embodiment 1 of the present invention.

FIG. 6 is a view illustrating a vague reply database stored in the storage section of the server in accordance with Embodiment 1 of the present invention.

FIG. 7 is a view illustrating a prompting reply database stored in the storage section of the server in accordance with Embodiment 1 of the present invention.

FIG. 8 is a block diagram illustrating a main configuration of a speaking system in accordance with Embodiment 2 of the present invention.

FIG. 9 is a sequence diagram illustrating a replying voice output process of the speaking system in accordance with Embodiment 2 of the present invention.

FIG. 10 is a block diagram illustrating a main configuration of a speaking system in accordance with Embodiment 3 of the present invention.

FIG. 11 is a sequence diagram illustrating a flow of a replying voice output process of the speaking system in accordance with Embodiment 3 of the present invention.

FIG. 12 is a block diagram illustrating a main configuration of a speaking system in accordance with Embodiment 4 of the present invention.

FIG. 13 is a sequence diagram illustrating a flow of a replying voice output process of the speaking system in accordance with Embodiment 4 of the present invention.

FIG. 14 is a block diagram illustrating a main configuration of a speaking system in accordance with Embodiment 5 of the present invention.

### DESCRIPTION OF EMBODIMENTS

### Embodiment 1

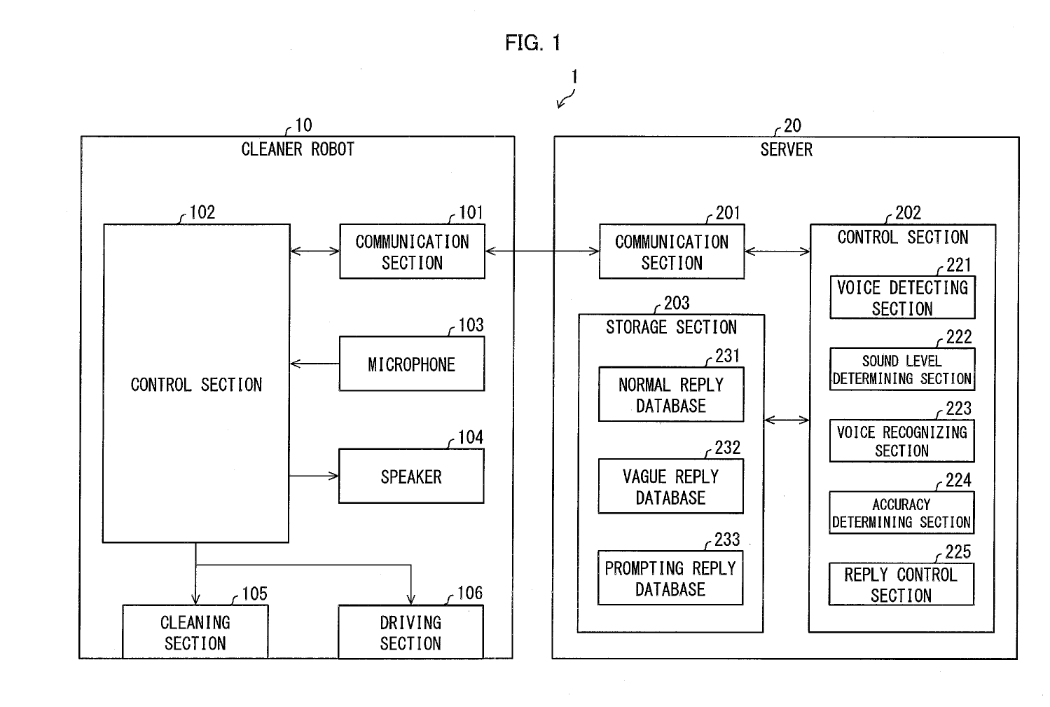

The following description will discuss a speaking system 1 of Embodiment 1 with reference to FIGS. 1 through 7. Note, however, that the present invention is not limited to a configuration described in Embodiment 1 unless specifically stated otherwise, and the configuration is illustrative only.

[Overview of Speaking System]

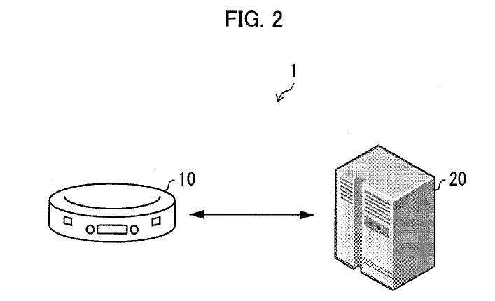

First, an overview of the speaking system 1 will be described below with reference to FIG. 2. FIG. 2 is an external view showing an overview of the speaking system 1.

As illustrated in FIG. 2, the speaking system 1 of Embodiment 1 includes a cleaner robot (speaking device) 10 and a server 20.

The speaking system 1 is configured such that in a case where a voice uttered by a human (user) is inputted into the cleaner robot 10, the cleaner robot 10 outputs a voice (hereinafter also referred to as “replying voice”) communicating reply content which is determined by the server 20 and is communicated in reply to the voice inputted by the user. This is how the speaking system 1 realizes a virtual conversation between the user and the cleaner robot 10.

Note that although the cleaner robot 10 is employed in Embodiment 1 as an example of a voice output device for outputting a replying voice to a user, the present invention is limited to such a configuration. Other examples of the voice output device encompass a human figure equipped with a function to output a voice and home electrical appliances (such as television and microwave oven) other than the cleaner robot 10.

In addition, although Embodiment 1 discusses an example in which the server 20 is realized by one server, the present invention is not limited to such a configuration. In fact, it is possible to employ a configuration in which at least part of members (functions) included in the server 20 is realized by use of another server.

Next, a main configuration of the speaking system 1 of Embodiment 1 will be described below with reference to FIG. 1. FIG. 1 is a block diagram illustrating a main configuration of the speaking system 1.

[Cleaner Robot]

The configuration of the cleaner robot 10 in accordance with Embodiment 1 will be described below with reference to FIG. 1. As illustrated in FIG. 1, the cleaner robot 10 includes a communication section (voice data transmitting section, answer data receiving section) 101, a control section 102, a microphone 103, a speaker (answer outputting section) 104, a cleaning section 105, and a driving section 106.

(Communication Section)

The communication section 101 is a section to communicate with external device. Specifically, the communication section 101 wirelessly communicates with the server 20 via a network such as the Internet.

(Microphone)

The microphone 103 receives an audio input from an external source. Note that, in Embodiment 1, “audio data” indicating a sound received by/inputted into the microphone 103 encompass (i) data containing a frequency band of a voice uttered mainly by a human (hereinafter, such data will also be referred to as “voice data”) and (ii) data containing frequency bands outside the frequency band of the voice data (hereinafter, such data will also be referred to as “other audio data”).

The microphone 103 sequentially supply, to the control section 102, audio data indicative of a sound inputted.

(Speaker)

The speaker 104 outputs a replying voice communicating reply content indicated by reply content data which has been supplied from the control section 102. Hereinafter, an act of the cleaner robot 10 outputting a replying voice via the speaker 104 will also referred to as “speaking.” The details of reply content will be described later.

(Cleaning Section, Driving Section)

The cleaning section 105 realizes a function of a cleaner in accordance with an instruction from the control section 102. The driving section 106 moves the cleaner robot 10 in accordance with an instruction from the control section 102.

The cleaner robot 10 can carry out automatic cleaning of a room by causing the cleaning section 105 and the driving section 106 to operate in combination.

(Control Section)

The control section 102 controls the members of the cleaner robot 10 all together. Specifically, the control section 102 controls a cleaning operation of the cleaner robot 10 by controlling the cleaning section 105 and the driving section 106. In addition, the control section 102 sequentially transmits, to the server 20 via the communication section 101, audio data indicative of a sound which has been obtained by the microphone 103 from an external source.

The functions of the control section 102 are realized by, for example, causing a CPU (Central Processing Unit) to execute a program stored in a storage device such as RAM (Random Access Memory) or flash memory (none of these is illustrated).

The control section 102 also obtains reply content data from the server 20 via the communication section 101. Then, the control section 102 controls (drives) the speaker 104 to output a voice communicating reply content indicated by the reply content data thus obtained.

[Server]

A configuration of the server 20 in accordance with Embodiment 1 will be described next with reference to FIG. 1. As illustrated FIG. 1, the server 20 includes a communication section (voice data receiving section) 201, a control section 202, and a storage section 203.

(Communication Section)

The communication section 201 is a section to communicate with an external device. Specifically, the communication section 201 wirelessly communicates with the cleaner robot 10 via a network such as the Internet.

(Control Section)

The control section 202 controls the members of the server 20 all together. The function of the control section 202 are realized by, for example, causing a CPU (Central Processing Unit) to execute a program stored in a storage device such as RAM (Random Access Memory) or flash memory (none of these is illustrated).

The details of a configuration of the control section 202 will be described later.

(Storage Section)

The storage section 203 stores various data to which the control section 202 (described later) refers. Examples of the various data encompass (i) a speech waveform model (not illustrated) to which the accuracy determining section 224 refers, the speech waveform model indicating predetermined words and (ii) a reply option table (not illustrated), a normal reply database (first database) 231, a vague reply database (second database) 232, and a prompting reply database 233, to each of which the reply control section 225 refers.

Note that the details of the reply option table and the details of the databases 231 through 233 will be described later with reference to different drawings.

[Configuration of Control Section]

The configuration of the control section 202 included in the server 20 will be described next with reference to FIG. 1. As illustrated FIG. 1, the control section 202 includes a voice detecting section 221 (extracting section), a sound level determining section 222, a voice recognizing section (recognition accuracy determining section) 223, an accuracy determining section (recognition accuracy determining section) 224, and a reply control section (answer transmitting section, answer option switching section) 225.

(Voice Detecting Section)

The voice detecting section 221 detects (extracts) voice data from audio data transmitted from the cleaner robot 10. In other words, the voice detecting section 221 extracts, from audio data received from an external source, a frequency band of a voice uttered by a human so that the voice detecting section 221 serves as an extracting section configured to generate target audio data (voice data) to be subjected to a determining process carried out by the sound level determining section 222 (described later).

The voice detecting section 221 detects voice data from audio data by, for example, extracting a frequency band of a human voice (e.g. a frequency band of 100 Hz or greater and 1 kHz or less) from the audio data. In such a case, in order to extracting the frequency band of a human voice from the audio data, the voice detecting section 221 can include a band-pass filter or a filter in which a high-pass filter and a low-pass filter are combined together.

The voice detecting section 221 then supplies, to the sound level determining section 222 and the voice recognizing section 223, the voice data which has been detected from the audio data.

(Sound Level Determining Section)

The sound level determining section 222 determines a sound level of voice data (target audio data) detected by the voice detecting section 221. Specifically, the sound level determining section 222 first compares the sound level of the voice and two threshold values (threshold value a (second sound-level threshold value) and threshold value b (first sound-level threshold value): threshold value a>threshold value b). Then, the sound level determining section 222 determines which of the following ranges the sound level of the voice belongs to: (1) sound level>threshold value a, (2) threshold value a≧sound level≧threshold value b, and (3) threshold value b>sound level. Note that the range (2) corresponds to a sound-level range between a first sound-level threshold value (threshold value b) or greater and a second sound-level threshold value (threshold value a) or less. In other words, the sound level determining section 222 determines (i) whether or not the sound level of the voice indicated by the voice data falls within a first predetermined sound-level range (threshold value a≧sound level≧threshold value b) and (ii) whether or not the sound level falls within a second predetermined sound-level range (threshold value b>sound level) which is lower than the first predetermined sound-level range.

Note that the threshold value a and the threshold value b are preferably “−20 dB” and “−39 dB”, respectively. However, the present invention is not limited to these values. The threshold value a may be set to a maximum value of a sound level of a voice that humans normally utter whereas the threshold value b may be set to a minimum value of the sound level that humans normally utter. This makes it possible to more accurately determine whether or not a sound is a voice of a human even in a case where, for example, the sound is a sound which (i) falls within a frequency band similar to a frequency band of a human voice (e.g. sound of a dog barking (generally 450 Hz to 1.1 kHz)) and (ii) is supplied from the cleaner robot 10 and is detected by the voice detecting section 221 as a human voice.

Although Embodiment 1 discusses an example in which voice data is employed as target audio data, the present invention is not limited to such an example. For example, the sound level determining section 222 may obtain audio data from the cleaner robot 10 and then use, as is, the audio data as target audio data.

The sound level determining section 222 supplies, to the reply control section 225, a determined result of determining the sound level of the voice.

(Voice Recognizing Section)

The voice recognizing section 223 recognizes, as recognition content, content (voice data content) of the voice indicated by the voice data detected by the voice detecting section 221. The voice recognizing section 223 then supplies, to the accuracy determining section 224, a recognition result of recognizing the voice data content from the voice data.

(Accuracy Determining Section)

The accuracy determining section 224 determines accuracy of the recognition result of the voice data content, which recognition result has been supplied from the voice recognizing section 223 (in other words, the accuracy of the recognizing process of recognizing the voice data content). That is, the accuracy determining section 224 serves as recognition accuracy determining section in combination with the voice recognizing section 223.

Specifically, the accuracy determining section 224 compares (i) the accuracy of the recognition result of recognizing the voice data content and (ii) two threshold values (threshold value c (first accuracy threshold value) and threshold value d (second accuracy threshold value): threshold value c>threshold value d). Then, the accuracy determining section 224 determines which of the following ranges the accuracy of the recognition result belongs to: (A) threshold value c≦recognition accuracy, (B) threshold value ≦d recognition accuracy<threshold value c, and (C) recognition accuracy<threshold value d. Note that the range (B) corresponds to an accuracy range between less than a first accuracy threshold value (threshold value c) and a second accuracy threshold value (threshold value d) or greater.

In a case where a minimum value of the recognition accuracy is set to “0” and a maximum value of the recognition accuracy is set to “1”, the threshold value c and the threshold value d are preferably “0.6” and “0.43”, respectively. However, the present invention is not limited to these values.

Note that as a method of determining recognition accuracy of a recognition result of the accuracy determining section 224, it is possible, for example, to (i) determine the degree of match between (a) a speech waveform model (acoustic model) indicative of a given one of a plurality of predetermined words (phrases) prepared in advance and (b) a waveform indicated by voice data and then (ii) designate a highest degree of match as the recognition accuracy. Note, however, that the present invention is not limited to such a method, but can employ, for example, pattern matching.

The accuracy determining section 224 supplies, to the reply control section 225, (i) the determined result of the recognition accuracy and (ii) the recognition result of the voice data content which has been supplied from the voice recognizing section 223.

(Reply Control Section)

In accordance with the determined result of the sound level supplied from the sound level determining section 222 and with the determined result of the recognition accuracy supplied from the accuracy determining section 224, the reply control section 225 determines reply content. In other words, the reply control section 225 switches between options for an answer to a user, depending on whether or not the voice data content supplied from the voice recognizing section 223 was recognized.

Specifically, the reply control section 225 determines which reply option (option for a reply to the voice data content indicated by the voice data) to select by referring to a reply option table (described later) and then by determining which of the ranges (1) through (3) the determined result of the sound level belongs to and determining which of the ranges (A) through (C) the determined result of the recognition accuracy belongs to. Then, by referring to the databases 231 through 233 stored in the storage section 203, the reply control section 225 determines reply content in accordance with the reply option thus determined. Note that the details of determining of reply option by the reply control section 225 with the use of the reply option table and the details of the databases stored in the storage section 203 will be described later with reference to different drawings.

Note also that, in Embodiment 1, examples of reply option to be determined by the reply control section 225 encompass (i) “normal reply” with which a reply is made to recognition content in a normal manner, (ii) “vague reply” with which a reply is vaguely made to the recognition content, (iii) “conversation prompting” which prompts a user to converse (speak), and (iv) “no reply” with which no reply is made.

When the reply content is determined, the reply control section 225 transmits, to the cleaner robot 10 via the communication section 201, reply content data indicative of the reply content.

Embodiment 1 discussed the example in which the reply control section 225 determines reply content in accordance with a determined result of a sound level and with a determined result of recognition accuracy. However, the present invention is not limited to such an example. For example, the reply control section 225 may determine reply content in accordance with a recognition result of voice data content supplied from the voice recognizing section 223. In addition, the reply control section 225 may determine reply content in accordance with a determined result of a sound level and with a recognition result of voice data content. The reply control section 225 can also determine reply content in accordance with a determined result of recognition accuracy and with a recognition result of voice data content.

[Replying Voice Output Process]

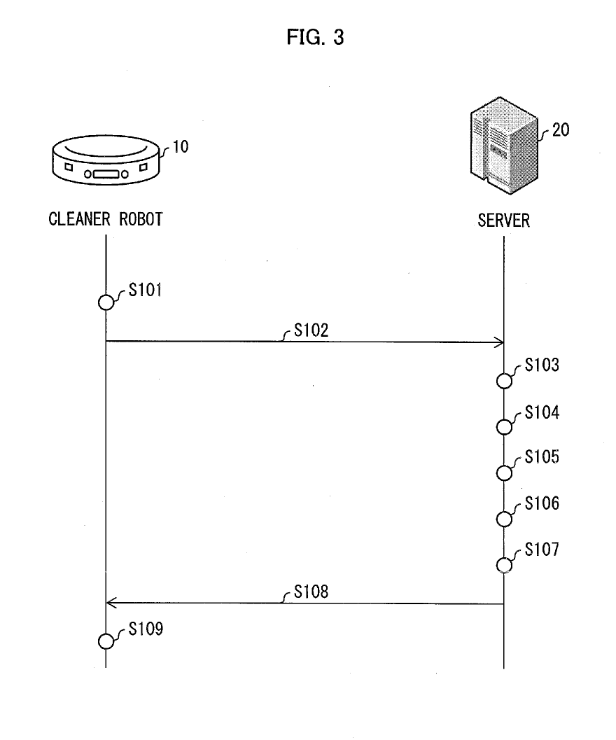

A replying voice output process (speaking control method) of the speaking system 1 in accordance with Embodiment 1 will be described next with reference to FIG. 3. FIG. 3 is a sequence diagram illustrating a flow of the replying voice output process of the speaking system 1.

Step S101: As illustrated in FIG. 3, the microphone 103 included in the cleaner robot 10 of the speaking system 1 receives input of a sound from an external source.

Step S102: After the microphone 103 receives the input of the sound, the control section 102 transmits, to the server 20 via the communication section 101, audio data indicated by the sound which has been inputted.

Step S103 (extracting step): After the audio data is obtained from the cleaner robot 10 via the communication section 201, the voice detecting section 221 included in the control section 202 of the server 20 detects voice data from the audio data. After the voice data is detected, the voice detecting section 221 supplies to the voice data to the sound level determining section 222 and to the voice recognizing section 223.

Step S104 (sound level determining step): After obtaining the voice data, the sound level determining section 222 determines a sound level of a voice indicated by the voice data thus received. Specifically, the sound level determining section 222 (i) compares the sound level of the voice indicated by the voice data and the threshold value a and the threshold value b, (ii) determines which of the ranges (1) through (3) the sound level of the voice belongs to, and then (iii) supplies a determined result to the reply control section 225.

Step S105 (recognition accuracy determining step): After obtaining the voice data, the voice recognizing section 223 recognizes content of the voice indicated by the voice data. Then, the voice recognizing section 223 supplies a recognition result of the voice data content to the accuracy determining section 224.

Step S106: After obtaining the recognition result of the voice data content, the accuracy determining section 224 determines accuracy of the recognition result. Specifically, the accuracy determining section 224 (i) determines which of the ranges (A) through (C) the accuracy of the recognition result belongs to and then (ii) supplies a determined result to the reply control section 225.

Step S107 (Switching Step): In accordance with the determined result of the sound level of the voice supplied from the sound level determining section 222 and with the determined result of the accuracy supplied from the accuracy determining section 224, the reply control section 225 determines a reply option and reply content.

Step S108 (Transmitting Step): After the reply content is determined by the reply control section 225, the control section 202 supplies, to the cleaner robot 10 via the communication section 201, reply content data indicative of the reply content.

Step S109: After receiving the reply content data via the communication section 101, the control section 102 of the cleaner robot 10 outputs, via the speaker 104, a replying voice communicating the reply content data.

Since a replying voice output process is thus carried out in the speaking system 1, the cleaner robot 10 is capable of speaking in reply to a voice uttered by a human.

[Reply Option Table]

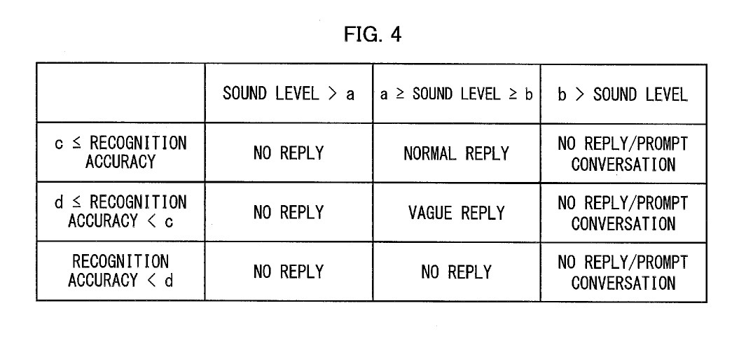

A process in which the reply control section 225 determines a reply option by referring to the reply option table will be described below with reference to FIGS. 4 through 7. FIG. 4 illustrates a reply option table stored in the storage section 203 of the server 20 in accordance with Embodiment 1.

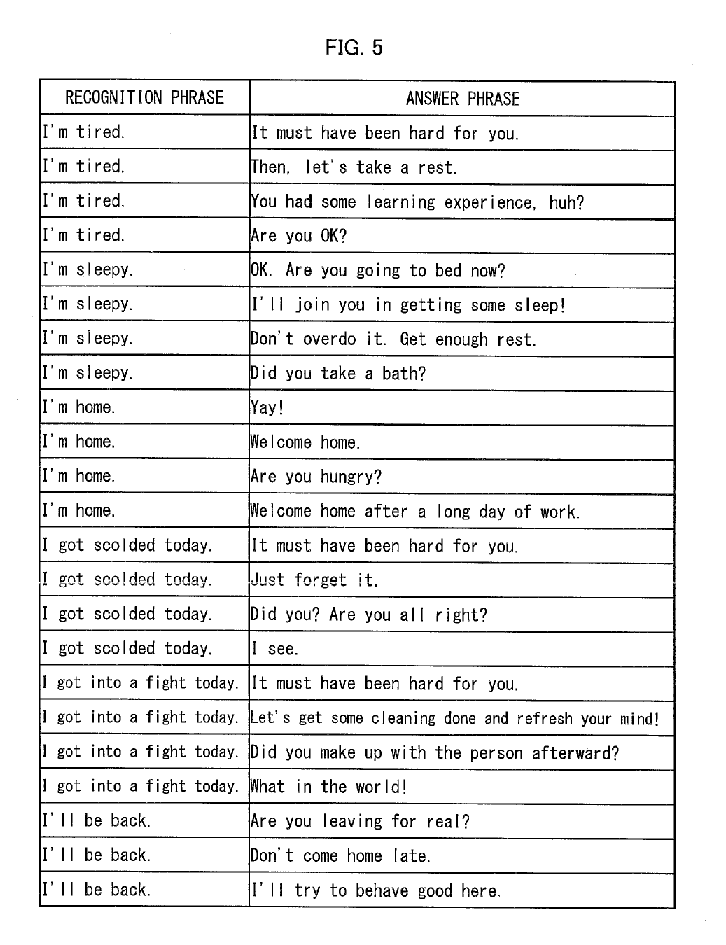

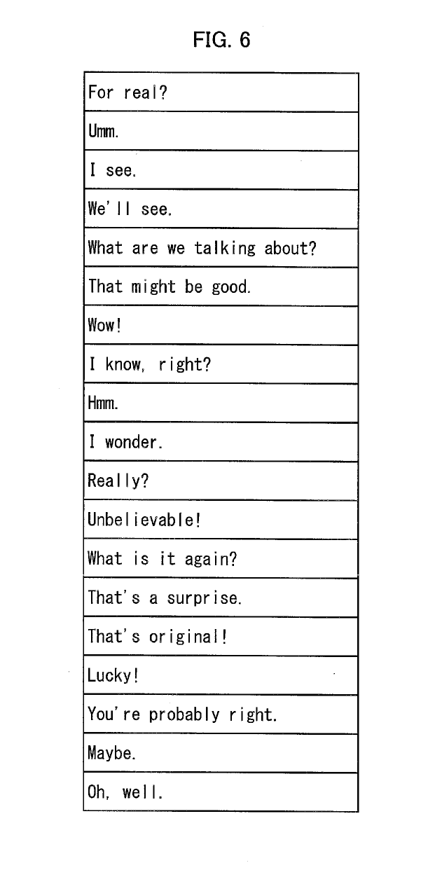

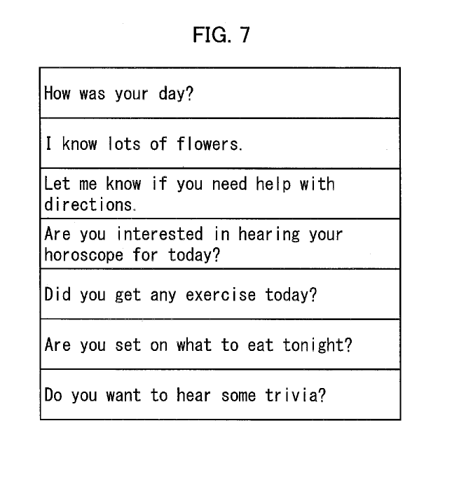

FIG. 5 is a view illustrating the normal reply database 231 stored in the storage section 203. FIG. 6 is a view illustrating the vague reply database 232 stored in the storage section 203. FIG. 7 is a view illustrating the prompting reply database 233 stored in the storage section 203.

As illustrated in FIG. 4, in a case where a determined result of a sound level of a voice meets “sound level>threshold value a” (i.e. in a case of the range (1) described above), the reply control section 225 determines a reply option to be “no reply”, regardless of a determined result of recognition accuracy.

In a case where the determined result of the sound level of the voice meets “threshold value b>sound level” (i.e. in a case of the range (3); in a case where the sound level falls within the second predetermined sound-level range), the reply control section 225 determines a reply option to be “no reply” or “conversation prompting”, regardless of the determined result of the recognition accuracy.

Then, in the case where the determined result of the sound level meets the range (3), the reply control section 225 determines, with a predetermined chance, the reply option to be “conversation prompting.” In other words, in a case where the sound level of the voice determined by the sound level determining section 222 is smaller than the threshold value b, the reply control section 225 transmits, with the predetermined chance, a phrase prompting a conversation (answer data indicative of content that prompts a conversation) (described later in detail). Note that although the predetermined chance is preferably 1/10 in Embodiment 1, the present invention is not limited to any particular chance. For example, the predetermined chance may be 1/100.

In a case where the determined result of the sound level of the voice meets “threshold value a sound level threshold value b” (i.e. in a case where of the range (2); in a case where the sound level falls within the first predetermined sound-level range), the reply control section 225 determines a reply option in accordance with the determined result of the recognition accuracy. In other words, the reply control section 225 switches between reply options (answer options), depending on whether or not the content indicated by the voice was recognized.

To be more specific, in a case where the determined result of the recognition accuracy meets “threshold value d recognition accuracy” (in a case where the recognition accuracy falls within a first predetermined recognition accuracy range), the content indicated by the voice is determined as recognized, and therefore the reply option is determined to be “normal reply” or “vague reply.” In more detail, in a case where the determined result of the recognition accuracy meets “threshold value c recognition accuracy” (i.e. the range (A)) (in a case where the recognition accuracy (i) falls within the first predetermined recognition accuracy range and (ii) falls within the second predetermined recognition accuracy range falling within part of the first predetermined recognition accuracy range, which part shows relatively high recognition accuracy), the reply option is determined to be “normal reply.” In a case where the determined result meets “threshold value d recognition accuracy<threshold value c” (i.e. the range (B)), the reply option is determined to be “vague reply.” In a case where the determined result meets “recognition accuracy<threshold value d” (i.e. the range (C)), the reply option is determined to be “no reply.” The reply control section 225 thus changes, in accordance with recognition accuracy indicative of accuracy of a recognizing process of recognizing voice data content as recognition content, a database to which to refer in order to determine answer content of an answer to a user.

The case of “threshold value d≦recognition accuracy<threshold value c” (i.e. the range (B)) can also be described as a case where the content indicated by the voice was not recognized. This is because, in such a case, the reply control section 225 determines the reply option to be “vague reply.” In other words, the reply control section 225 can be configured such that, in a case where the content indicated by the voice was not recognized, the reply control section 225 refers to a database (vague reply database) in which answer content of an answer to voice data content includes a phrase(s) which does/do not apply to one-to-one correspondence or one-to-many correspondence.

Note that “normal reply” is a reply option with which a reply is made to recognition content in a normal manner. More specifically, “normal reply” is a reply option (first answer) with which a reply is made by use of a phrase (normal reply phrase) that (i) applies to one-to-one correspondence (or one-to-many correspondence) with respect to recognition content and (ii) is associated with the recognition content (i.e. is relative to the recognition content).

In a case where the reply option is determined to be “normal reply” and where recognition content (“recognition phrase” shown in FIG. 5) is “I got scolded today”, for example, the reply control section 225 only needs to determine, as reply content, at least one of the following phrases (“answer phrases” shown in FIG. 5): “It must have been hard for you”, “Just forget it”, “Did you? Are you all right?”, and “I see” (see FIG. 5).

FIG. 5 illustrates the normal reply database 231 stored in the storage section 203 included in the server 20. As illustrated in FIG. 5, the normal reply database 231 stores recognition content (recognition phrases) and reply content (answer phrases) in association with each other.

A “vague reply” is a reply option with which a reply is vaguely made to recognition content. More specifically, “vague reply” is a reply option (second answer) with which a reply is made by use of a phrase (vague phrase) that does not apply to one-to-one correspondence (or one-to-many correspondence) with respect to recognition content, such as a brief response (i.e. phrase loosely related to the recognition content). The vague phrase can also be described as a phrase (reply content) determined (selected) from the vague reply database 232 containing answer data (reply content) that are different in category from that contained in the normal reply database 231 to which to refer in a case where the recognition accuracy is the threshold value c or greater. Furthermore, the vague phrase can also be described as a phrase implying that (i) the content of the voice data is not recognized or (ii) there is no answer data to the content of the voice data recognized.

In a case where the reply option is determined to be a vague reply, the reply control section 225 only needs to determine, as reply content, one of the phrases such as “For real?”, “Umm”, and “I see” shown in FIG. 6, regardless of the recognition content. That is, in a case where the reply option is determined to be “vague reply”, the reply control section 225 can randomly select reply content from the vague reply database 232.

FIG. 6 illustrates the vague reply database 232 stored in the storage section 203 included in the server 20 of Embodiment 1. As illustrated in FIG. 6, the storage section 203 only stores reply content.

A “conversation prompting” is a reply option with which a phrase is outputted in reply to a user (human located in the vicinity of the cleaner robot 10), which reply prompts the user to converse (speak). Examples of the phrase encompass “How was your day?”, “Do you want to hear some trivia?” as shown in FIG. 7. These phrases that prompt a conversation are stored as the prompting reply database 233 in the storage section 203.

Embodiment 1 discussed the example in which the server 20 transmits to the cleaner robot 10 reply content data indicative of reply content (i.e. the server 20 supplies the reply content data indicative of the reply content which the cleaner robot 10 will communicate). However, the present invention is not limited to such an example. For example, it is possible that (i) the cleaner robot 10 includes a storage section (not illustrated) in which each database described above is stored and (ii) the server 20 transmits, to the cleaner robot 10, data that specifies which phrase of which database is to be designated as reply content.

With the configuration, it is possible to prevent the server 20 from transmitting, to the cleaner robot 10 with an inappropriate timing, reply content data in reply to a sound inputted into the cleaner robot 10

### Embodiment 2

Embodiment 1 discusses the example in which voice data is detected in the server 20 from audio data which has been received from the cleaner robot 10. However, the present invention is not limited to such an example. For example, it is possible to cause a cleaner robot to detect voice data and then transmit the voice data to a server.

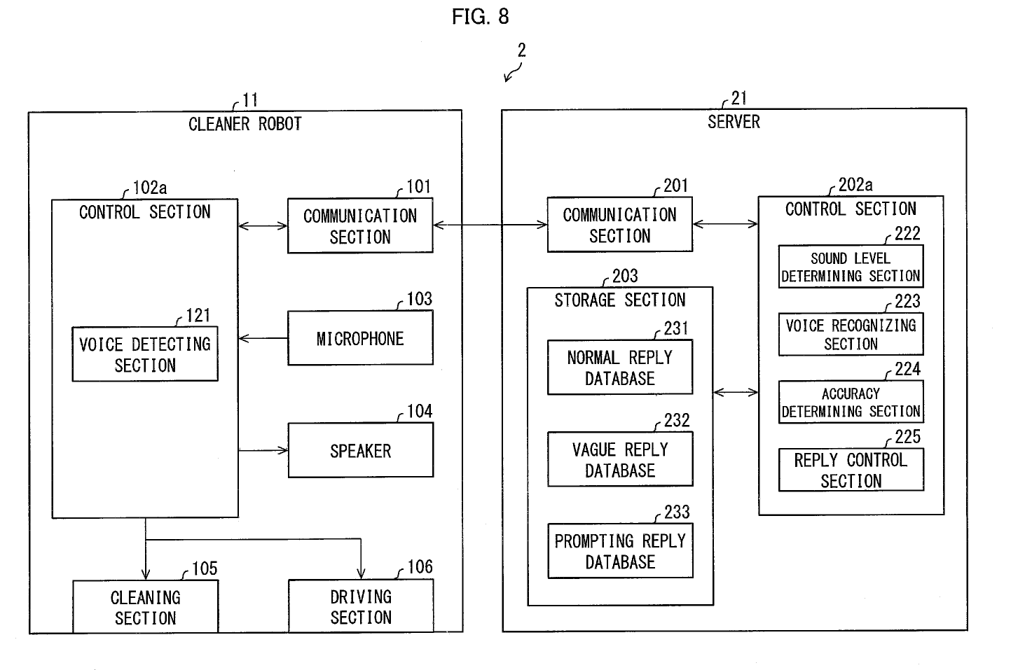

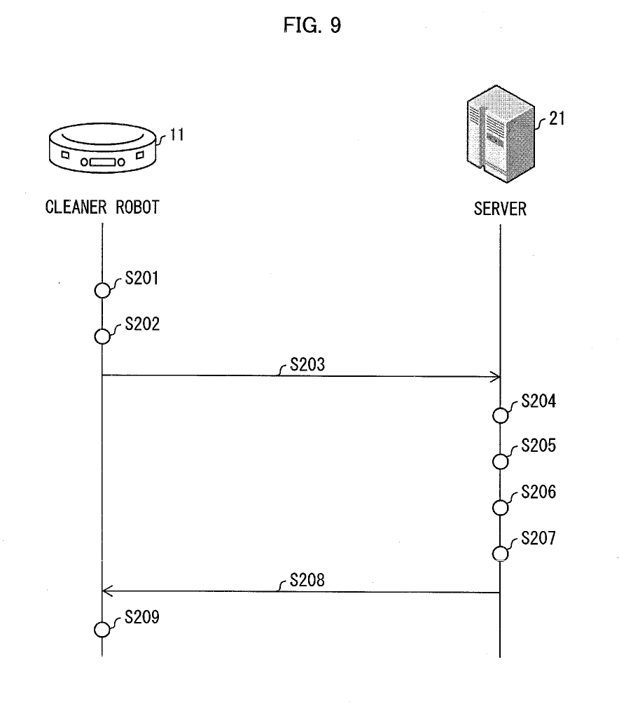

The following description will discuss another embodiment of the present invention with reference to FIGS. 8 and 9. For convenience, members similar in function to the members described in Embodiment 1 will be assigned the same reference signs, and their description will be omitted.

[Configuration of Speaking System]

FIG. 8 is a block diagram illustrating a main configuration of a speaking system 2 in accordance with Embodiment 2. As illustrated in FIG. 8, the speaking system 2 includes a cleaner robot 11 and a server 21.

As illustrated in FIG. 8, the cleaner robot 11 and the server 21 are similar in configuration to the cleaner robot 10 and the server 20, respectively, except that a control section 102a of the cleaner robot 11, instead of a control section 202a of the server 21, includes a voice detecting section (voice data extracting section) 121.

(Configurations of Cleaner Robot and Server)

A voice detecting section 121 included in the control section 102a detects voice data from audio data that indicates a sound obtained via a microphone 103. In other words, the voice detecting section 121 serves as a receiving section configured to receive audio data (voice data) containing only a frequency band of human voices. The control section 102a sequentially supplies, to the server 21 via a communication section 101, the voice data which has been detected by the voice detecting section 121.

The control section 202a obtains the voice data from the cleaner robot 11 via a communication section 201, and then causes sound level determining section 222 through reply control section 225 to determine reply content in accordance with the voice data. Then, the control section 202a transmits, to the cleaner robot 11 via the communication section 201, reply content data indicative of the reply content thus determined.

Then, the cleaner robot 11 speaks in accordance with the reply content data thus received from the server 21.

[Replying Voice Output Process]

A replying voice output process of the speaking system 2 in accordance with Embodiment 2 will be described next with reference to FIG. 9. FIG. 9 is a sequence diagram illustrating a flow of the replying voice output process of the speaking system 2.

Step S201: As illustrated in FIG. 9, the microphone 103 included in the cleaner robot 11 of the speaking system 2 first receives input of a sound from an external source.

Step S202: After the microphone 103 receives the input of the sound, the voice detecting section 121 included in the control section 102a detects (extracts) voice data from audio data indicative of the sound thus inputted.

Step S203: After the voice data is detected by the voice detecting section 121, the control section 102a transmits the voice data to the server 21 via the communication section 101. After the voice data is received, the control section 202a included in the server 21 supplies the voice data to the sound level determining section 222 and to the voice recognizing section 223.

Note that processes involved in steps S204 (receiving step) through 5209 illustrated in FIG. 9 are similar to those involved in the steps S104 through S109 illustrated in FIG. 3, and their description will be therefore omitted.

Since the replying voice output process is thus carried out in the speaking system 2, the cleaner robot 11 is capable of speaking in reply to a voice uttered by a human.

### Embodiment 3

Embodiment 1 discussed the example in which a sound level of a voice indicated by voice data was determined in the server 20. However, the present invention is not limited to such an example. For example, it is possible to configure a cleaner robot to (i) determine a sound level of a voice and then (ii) transmit, to a server, (a) a determined result of the sound level and (b) voice data.

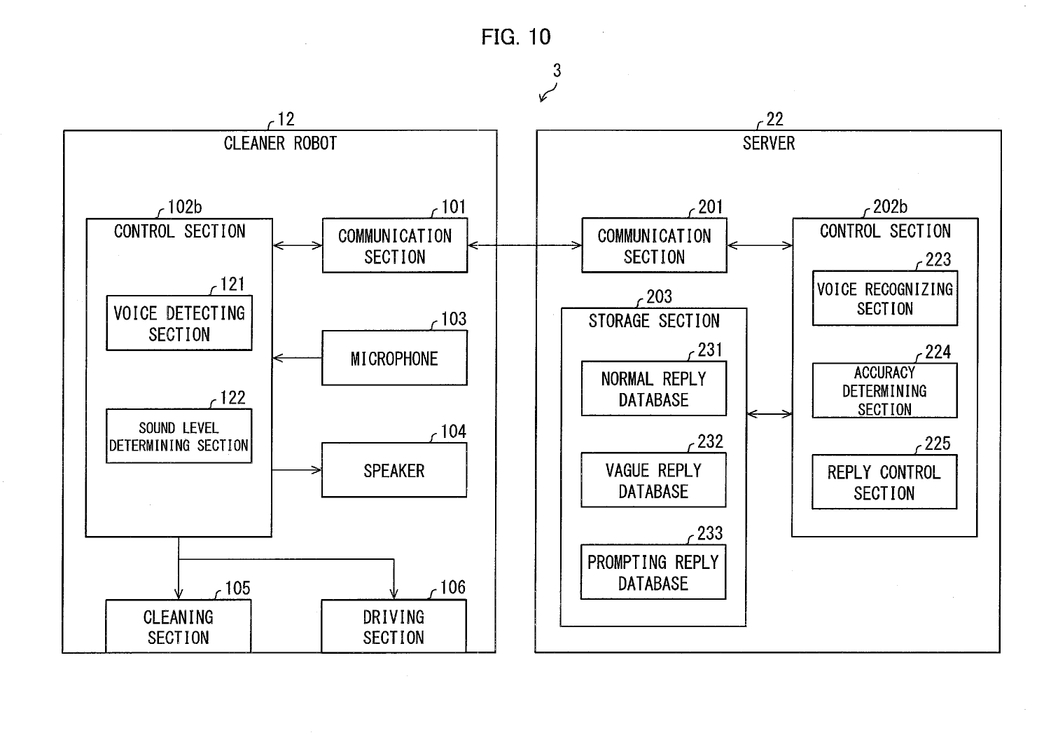

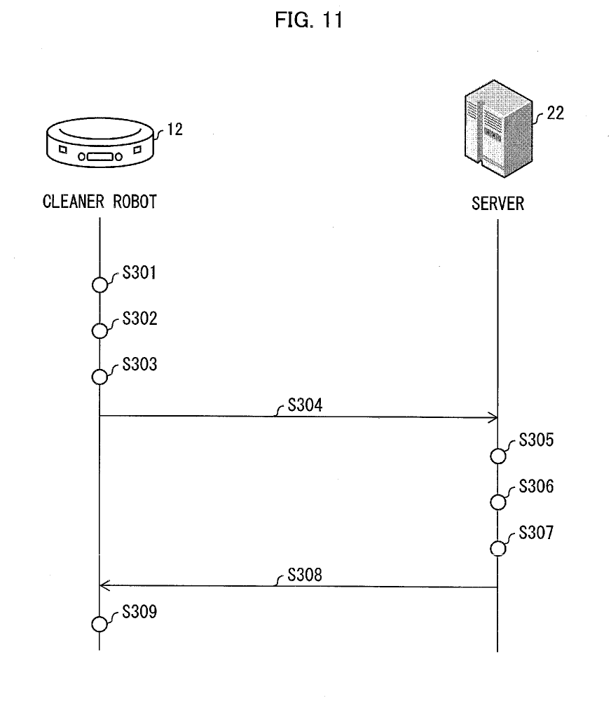

The following description will discuss another embodiment of the present invention with reference to FIGS. 10 and 11. For convenience, members similar in function to the members described in Embodiment 1 will be assigned the same reference signs, and their description will be omitted.

[Configuration of Speaking System]

FIG. 10 is a block diagram illustrating a main configuration of a speaking system 3 in accordance with Embodiment 3. As illustrated in FIG. 10, the speaking system 3 includes a cleaner robot 12 and a server 22.

As illustrated in FIG. 10, the cleaner robot 12 and the server 22 are similar in configuration to the cleaner robot 10 and the server 20 of Embodiment 1, respectively, except that a control section 102b of the cleaner robot 12, instead of a control section 202b of the server 22, includes a voice detecting section 121 and a sound level determining section 122.

(Configurations of Cleaner Robot and Server)

The voice detecting section 121 included in the control section 102b of the cleaner robot 12 detects voice data from audio data indicative of a sound obtained via a microphone 103. In other words, the voice detecting section 121 serves as a receiving section configured to receive audio data (voice data) containing only a frequency band of human voices. The voice detecting section 121 then supplies the voice data to the sound level determining section 122.

The sound level determining section 122 then determines a sound level of a voice indicated by the voice data detected by the voice detecting section 121. Note that a method employed by the sound level determining section 122 to determine a sound level is similar to that employed by the sound level determining section 222 included in the server 20 of Embodiment 1, and therefore its detailed description will be omitted. The sound level determining section 122 sequentially transmits, to the server 22 via a communication section 101, (i) a determined result of the sound level and (ii) voice data detected by the voice detecting section 121.

After the voice data and the determined result of the sound level are obtained from the cleaner robot 12 via a communication section 201, the control section 202b included in the server 22 causes voice recognizing section 223 through reply control section 225 to determine reply content in accordance with the voice data. The control section 202b then transmits, to the cleaner robot 12 via the communication section 201, reply content data indicative of the reply content thus determined.

Then, the cleaner robot 12 speaks in accordance with the reply content data thus received from the server 22.

[Replying Voice Output Process]

A replying voice output process of the speaking system 3 in accordance with Embodiment 3 will be described next with reference to FIG. 11. FIG. 11 is a sequence diagram illustrating a flow of the replying voice output process of the speaking system 3.

Step S301: As illustrated in FIG. 11, the microphone 103 included in the cleaner robot 12 of the speaking system 3 first receives input of a sound from an external source.

Step S302: After the microphone 103 receives the input of the sound, the voice detecting section 121 included in the control section 102b detects (extracts) voice data from audio data indicative of the sound thus inputted. After the voice data is detected, the voice detecting section 121 supplies the voice data to the sound level determining section 122.

Step S303: After the voice data is obtained from the voice detecting section 121, the sound level determining section 122 determines a sound level of a voice indicated by the voice data.

Step S304: The control section 102b transmits, to the server 21 via the communication section 101, (i) a determined result of the sound level and (ii) the voice data. After the determined result of the sound level and the voice data are received, a control section 202a included in the server 21 (a) supplies the voice data to the voice recognizing section 223 and (b) supplies the determined result of the sound level to the reply control section 225.

Note that processes involved in steps S305 through S309 illustrated in FIG. 11 are similar to those involved in the steps S105 through S109 illustrated in FIG. 3, and their description will be therefore omitted.

Since the replying voice output process is thus carried out in the speaking system 3, the cleaner robot 12 is capable of speaking in reply to a voice uttered by a human.

### Embodiment 4

Embodiment 1 discussed the example in which recognition accuracy of voice data content recognized from voice data is determined in the server 20. However, the present invention is not limited to such an example. For example, it is possible configure a cleaner robot to (i) determine a recognition accuracy of a voice and then (ii) transmit, to a server, (a) a determined result of recognition accuracy of voice data content and (b) voice data.

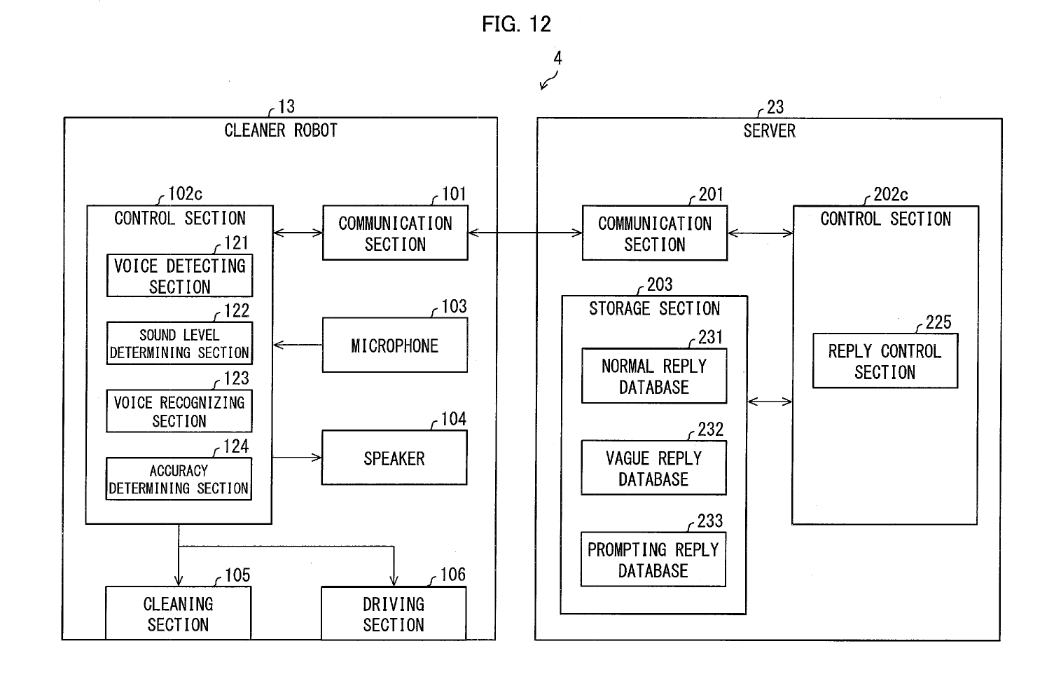

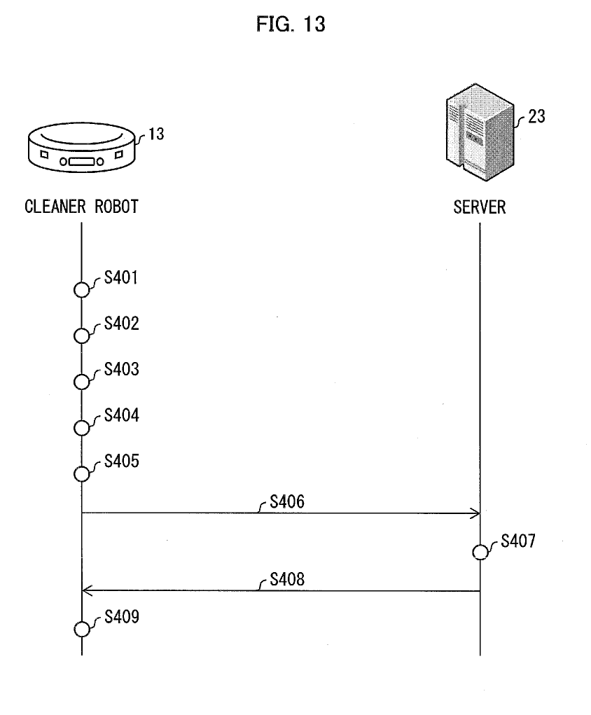

The following description will discuss another embodiment of the present invention with reference to FIGS. 12 and 13. For convenience, members similar in function to the members described in Embodiment 1 will be assigned the same reference signs, and their description will be omitted.

[Configuration of Speaking System]

FIG. 12 is a block diagram illustrating a main configuration of a speaking system 4 in accordance with Embodiment 4. As illustrated in FIG. 12, the speaking system 4 includes a cleaner robot 13 and a server 23.

As illustrated in FIG. 12, the cleaner robot 13 and the server 23 are similar in configuration to the cleaner robot 10 and the server 20 of Embodiment 1, respectively, except that a control section 102c of the cleaner robot 13, instead of a control section 202c of the server 23, includes a voice detecting section 121, a sound level determining section 122, a voice recognizing section (voice recognizing section) 123, and an accuracy determining section 124.

(Configurations of Cleaner Robot and Server)

The voice detecting section 121 included in the control section 102c of the cleaner robot 13 detects voice data from audio data indicative of a sound obtained via a microphone 103. In other words, the voice detecting section 121 serves as a receiving section configured to receive audio data (voice data) containing only a frequency band of human voices. The voice detecting section 121 then supplies the voice data to the sound level determining section 122 and to the voice recognizing section 123.

The sound level determining section 122 determines a sound level of a voice indicated by the voice data detected by the voice detecting section 121. Note that a method employed by the sound level determining section 122 to determine a sound level is similar to that employed by the sound level determining section 222 included in the server 20 of Embodiment 1, and therefore its detailed description will be omitted.

The voice recognizing section 123 recognizes, as recognition content, content (voice data content) of the voice indicated by the voice data detected by the voice detecting section 121. Then, the voice recognizing section 123 supplies, to the accuracy determining section 124, a recognition result of the voice data content recognized from the voice data.

(Accuracy Determining Section)

The accuracy determining section 124 determines recognition accuracy indicative of accuracy of the recognition result of the voice data content supplied from the voice recognizing section 123 (i.e. accuracy of a recognizing process of recognizing the voice data content). That is, the accuracy determining section 124 serves as recognition accuracy determining section in combination with the voice recognizing section 123. Note that a method employed by the accuracy determining section 124 to determine recognition accuracy is similar to that employed by the accuracy determining section 224 included in the server 20 of Embodiment 1, and therefore its detailed description will be omitted.

The control section 102c sequentially transmits, to the server 23 via the communication section 101, (i) a determined result of the sound level of the voice, (ii) the recognition result of the voice data content, (iii) a determined result of the recognition accuracy, and (iv) the voice data.

After obtaining the voice data, the determined result of the sound level, the recognition result of the voice data content, and the determined result of the recognition accuracy from the cleaner robot 13 via a communication section 201, the control section 202c included in the server 23 causes a reply control section 225 to determine reply content. Then, the control section 202c transmits, to the cleaner robot 13 via the communication section 201, reply content data indicative of the reply content thus determined.

Then, the cleaner robot 13 speaks in accordance with the reply content data thus received from the server 23.

[Replying Voice Output Process]

A replying voice output process of the speaking system 4 in accordance with Embodiment 4 will be described next with reference to FIG. 13. FIG. 13 is a sequence diagram illustrating a flow of the replying voice output process of the speaking system 4.

Step S401: As illustrated in FIG. 13, the microphone 103 included in the cleaner robot 13 of the speaking system 4 receives input of a sound from an external source.

Step S402: After the microphone 103 receives the input of the sound, the voice detecting section 121 included in the control section 102c detects (extracts) voice data from audio data indicative of the sound thus inputted. After the voice data is detected, the voice detecting section 121 supplies the voice data to the sound level determining section 122 and to the voice recognizing section 123.

Step S403: After obtaining the voice data, the sound level determining section 122 determines a sound level of a voice indicated by the voice data.

Step S404: After obtaining the voice data, the voice recognizing section 123 recognizes voice data content of the voice indicated by the voice data. Then, the voice recognizing section 123 supplies, to the accuracy determining section 124, a recognition result of recognizing the voice data content.

Step S405: After obtaining the recognition result of the voice data content, the accuracy determining section 124 determines accuracy of the recognition result.

Step S406: The control section 102c sequentially transmits, to the server 23 via the communication section 101, (i) a determined result of the sound level, (ii) the recognition result of the voice data content, (iii) a determined result of the recognition accuracy, and (iv) the voice data.

Note that processes involved in steps S407 through S409 illustrated in FIG. 13 are similar to those involved in the steps S107 through S109 illustrated in FIG. 3, and their description will be therefore omitted.

Since the replying voice output process is thus carried out in the speaking system 4, the cleaner robot 13 is capable of speaking in reply to a voice uttered by a human.

### Embodiment 5

The above embodiments discussed the examples of a speaking system including a cleaner robot and a server. However, the present invention is not limited to such examples. For example, according to the present invention, it is possible to employ a speaking system in which no server is included.

[Configuration of Speaking System]

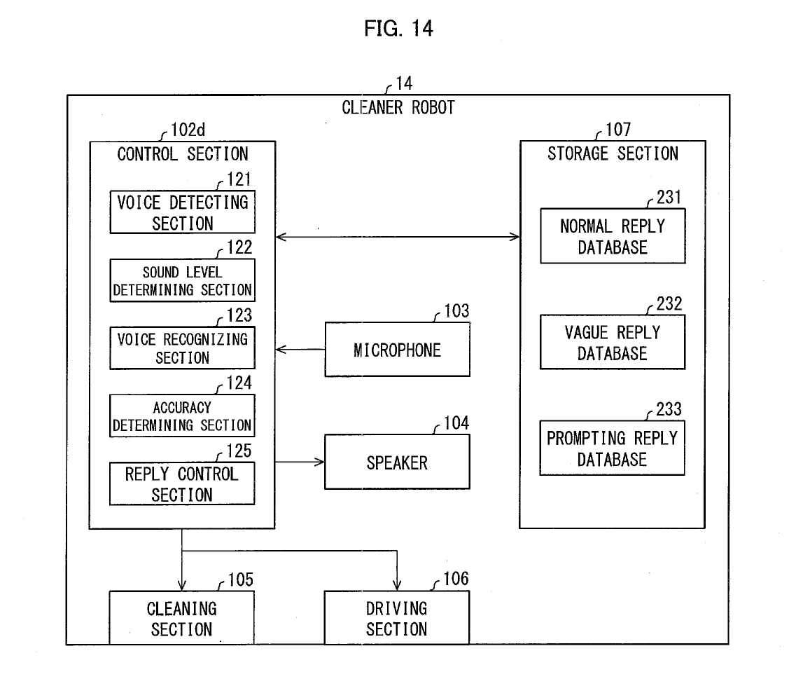

FIG. 14 is a block diagram illustrating a main configuration of a speaking system 5 in accordance with Embodiment 5. As illustrated in FIG. 14, the speaking system 5 includes a cleaner robot 14.

The cleaner robot 14 of Embodiment 5 includes, in addition to the members included in the cleaner robot 13 described above, a storage section 107 which is equivalent to a storage section 203 included in a server in accordance with the embodiment described above (see FIG. 14). Furthermore, the cleaner robot 14 includes a reply control section 125 in addition to the members included in the control section 102c of the cleaner robot 13.

(Reply Control Section)

The reply control section 125 determines reply content in accordance with (i) a determined result of a sound level of a voice, which determined result is supplied from a sound level determining section 122 and (ii) a determined result of recognition accuracy, which determined result is supplied from a accuracy determining section 124. Note that a method employed by the reply control section 125 to determine reply content is similar to that employed by the reply control section 225 included in the server 20 of Embodiment 1, and therefore its detailed description will be omitted.

[Replying Voice Output Process]

A replying voice output process of the speaking system 5 in accordance with Embodiment 5 will be described next. Processes involved in steps S401 through S405 are similar to those described with reference to FIG. 13, and therefore their detailed descriptions will be omitted.

After the step S405, the reply control section 125 determines a reply option and reply content in accordance with (i) a determined result of a sound level of a voice, which determined result is supplied from the sound level determining section 122 and (ii) a determined result of recognition accuracy, which determined result is supplied from the accuracy determining section 124. Then, the reply control section 125 outputs, via a speaker 104, a replying voice communicating the reply content thus determined.

According to the speaking system 5, the cleaner robot 14 is thus capable of speaking in reply to a voice uttered by a human although no server is included.

### Embodiment 6

Control blocks (particularly, control sections 102, 102a, 102b, 102c, and 102d and control sections 202, 202a, 202b, and 202c) provided in the cleaner robots 10 through 14 and the servers 20 through 23 may be realized by a logic circuit (hardware) provided in an integrated circuit (IC chip) or the like or may be realized by software as executed by a CPU (Central Processing Unit).

In the latter case, the cleaner robots 10 through 14 and the servers 20 through 23 each include: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

[Summary]

A speaking control method in accordance with Aspect 1 of the present invention includes: a switching step of switching between answer options for an answer to a user in a case where a sound level of target audio data falls within a first predetermined sound-level range, the answer options being associated with a case where audio data content indicated by the target audio data is recognized and a case where the audio data content is not recognized, respectively.

According to the configuration, in a case where the sound level of the target audio data falls within the first predetermined sound-level range, answer options for an answer to the user are switched, the answer options being associated with the case where the audio data content indicated by the target audio data is recognized and the case where the audio data content is not recognized. This, in the speaking control method, prevents answer data with respect to the target audio data from being transmitted with an inappropriate timing. In addition, in the speaking control method, it is possible to cause the user to learn whether or not the audio data content was recognized.

The speaking control method in accordance with Aspect 2 of the present invention can be configured in Aspect 1 such that in the case where the audio data content is recognized, a database containing a phrase whose answer content with respect to the audio data content does not apply to one-to-one correspondence or to one-to-many correspondence is referred to in the switching step.

According to the configuration, in a case where the audio data content is not recognized, a database containing a phrase whose answer content with respect to the audio data content does not apply to one-to-one correspondence or one-to-many correspondence, that is, the database containing a vague phrase with which a reply is vaguely made, is referred to in the speaking control method. Therefore, in a case where the audio data content is not recognized, it is possible with the speaking control method to cause the user to learn that the audio data content was not recognized.

The speaking control method in accordance with Aspect 3 of the present invention can be configured in Aspect 1 or 2 such that in the switching step, databases which are referred to in order to determine answer content in reply to the user are switched in accordance with recognition accuracy indicative of accuracy of a recognizing process in which the audio data content is recognized as recognition content.

According to the configuration, in the speaking control method, databases which are referred to in order to determine the answer content in reply to the user are switched in accordance with the recognition accuracy indicative of the accuracy of the recognizing process in which the audio data content is recognized as recognition content. This prevents, in the speaking control method, answer data with respect to the target audio data from being transmitted with an inappropriate timing. In addition, the server can cause the user to learn whether or not the audio data content was recognized.

The speaking control method in accordance with Aspect 4 of the present invention can be configured in Aspect 3 such that in the switching step, a referring process is carried out in a case where the recognition accuracy falls within a first predetermined recognition accuracy range, the referring process being associated with the case where the audio data content is recognized, in the switching step, the referring process being carried out to refer to: a database containing a phrase (i) whose answer content with respect to the recognition content applies to one-to-one correspondence or to one-to-many correspondence and (ii) which is relative to the recognition content; or a database containing a phrase whose answer content with respect to the recognition content does not apply to one-to-one correspondence or to one-to-many correspondence.

According to the configuration, in the speaking control method, a database containing a normal phrase or a vague phrase is referred to in a case where the audio data content is recognized. This prevents, in the speaking control method, answer data with respect to the target audio data from being transmitted with an inappropriate timing. In addition, the server can cause the user to learn that the audio data content was recognized.

The speaking control method in accordance with Aspect 5 of the present invention can be configured in Aspect 3 such that in a case where the recognition accuracy (i) falls within a first predetermined recognition accuracy range and (ii) falls within a second predetermined recognition accuracy range falling within part of the first predetermined recognition accuracy range which part shows relatively high recognition accuracy, a referring process is carried out in the switching step, the referring process being associated with the case where the audio data content is recognized, in the switching step, the referring process being carried out to refer to a database containing a phrase (i) whose answer content with respect to the recognition content applies to one-to-one correspondence or to one-to-many correspondence and (ii) which is relative to the recognition content.

According to the configuration, in the speaking control method, a database containing a normal phrase is referred to in a case where the audio data content is recognized. This prevents, in the speaking control method, answer data with respect to the target audio data from being transmitted with an inappropriate timing. In addition, the server can carry out more appropriate communication with the user.

The speaking control method in accordance with Aspect 6 of the present invention can be configured in any one of Aspects 2 through 5 such that in the switching step, answer data indicative of answer content in reply to the user is randomly selected from the database.

According to the configuration, in the speaking control method, answer data is randomly selected from each of the databases. This allows the server to carry out more appropriate conversational communication with the user.

The speaking control method in accordance with Aspect 7 of the present invention can be configured in any one of Aspects 1 through 6 such that in a case where the sound level of the target audio data falls within a second predetermined sound-level range which is lower than the first predetermined sound-level range, one of the following is selected as an answer option in reply to the user in the switching step: not answering the user; and answering the user so as to prompt a conversation.

According to the configuration, in a case where the sound level of the audio data is low, the server selects one of the following in the speaking control method: not answering the user; and answering the user so as to prompt a conversation. This allows the server to carry out more appropriate conversational communication.

A server (servers 20 through 23) in accordance with Aspect 8 of the present invention includes: an answer option switching section (reply control section 225) configured to switch between answer options for an answer to a user in a case where a sound level of target audio data falls within a first predetermined sound-level range, the answer options being associated with a case where audio data content indicated by the target audio data is recognized and a case where the audio data content is not recognized, respectively.

With the configuration, the server brings about advantageous effects similar to those produced by the speaking control method in accordance with Aspect 1.

A speaking device (cleaner robot 14) in accordance with Aspect 9 of the present invention includes: a voice data extracting section (voice detecting section 121) configured to extract, from audio data obtained, voice data containing only a frequency band of a human voice; a sound level determining section (sound level determining section 122) configured to determine a sound level of the voice data; a voice recognizing section (voice recognizing section 123) configured to recognize, in a case where the sound level is determined by the sound level determining section to fall within a predetermined sound-level range, voice data content as recognition content, which voice data content is indicated by the voice data; an answer option switching section (reply control section 125) configured to (i) switch between answer options for an answer to a user, the answer options being associated with a case where voice data content indicated by the voice data is recognized and a case where the voice data content is not recognized, respectively and (ii) determine answer content; and an answer outputting section (speaker 104) configured to output a voice indicative of the answer content thus determined by the answer option switching section.

With the configuration, the speaking device brings about advantageous effects similar to those produce by the speaking control method in accordance with Aspect 1.

A speaking system (speaking systems 2 through 4) in accordance with Aspect 10 of the present invention includes: a speaking device; and a server (servers 20 through 40), said speaking device (cleaner robots 11 through 13) including a voice data extracting section (voice detecting section 121) configured to extract, from audio data obtained, voice data containing only a frequency band of a human voice, a voice data transmitting section (communication section 101) configured to transmit the voice data, an answer data receiving section (communication section 101) configured to receive answer data with respect to the voice data, and an answer outputting section (speaker 104) configured to output, in a case where the answer data receiving section receives the answer data, a voice indicated by the answer data, said server including a voice data receiving section (communication section 201) configured to receive the voice data from the speaking device, a sound level determining section (sound level determining section 222) configured to determine a sound level of the voice data thus received by the voice data receiving section, an answer option switching section (reply control section 225) configured to (i) switch between answer options for an answer to a user in a case where the sound level of the voice data thus determined falls within a predetermined sound-level range, the answer options being associated with a case where voice data content indicated by the voice data is recognized and a case where the voice data content is not recognized, respectively and (ii) determine answer content, and an answer transmitting section (reply control section 225) configured to transmit answer data indicative of the answer content thus determined by the answer option switching section.

With the configuration, the speaking system brings about advantageous effects similar to those produced by the speaking control method in accordance with Aspect 1.

A speaking device (speaking devices 2 through 4) in accordance with Aspect 11 of the present invention includes: a voice data extracting section (voice detecting section 121) configured to extract, from audio data obtained, voice data containing only a frequency band of a human voice; a voice data transmitting section (communication section 101) configured to transmit the voice data; an answer data receiving section (communication section 101) configured to receive answer data with respect to the voice data; and an answer outputting section (speaker 104) configured to output, in a case where the answer data receiving section receives the answer data, a voice indicated by the answer data, the answer data being answer data indicative of answer content determined by switching between answer options for an answer to a user in a case where a sound level of the voice data transmitted by the voice data transmitting section falls within a predetermined sound-level range, the answer options being associated with a case where voice data content indicated by the voice data is recognized and a case where the voice data content is not recognized, respectively.

With the configuration, it is possible to realize a speaking device including a speaking system in accordance with Aspect 10.

A speaking control method in accordance with Aspect 12 of the present invention includes: a transmitting step of transmitting, in a case where a sound level of target audio data falls within a sound-level range between a first sound-level threshold value or greater and a second sound-level threshold value or less, answer data with respect to audio data content indicated by the target audio data.

According to the configuration, in a case where the sound level of the target audio data falls within the sound-level range between the first sound-level threshold value or greater and the second sound-level threshold value or less, an answer to the audio data content indicated by the target audio data is transmitted in the transmitting step. In other words, no answer data is transmitted in the transmitting step in a case where the sound level of the target audio data exceeds or falls below the sound-level range. This prevents, in the speaking control method, answer data with respect to the target audio data from being transmitted with an inappropriate timing.

A speaking control method in accordance with Aspect 13 of the present invention can further include in Aspect 12: a receiving step of receiving, as the target audio data, audio data containing only a frequency band of a human voice.

A speaking control method in accordance with Aspect 14 of the present invention can further include in Aspect 12: an extracting step of extracting a frequency band of a human voice from audio data received from an external source so that the target audio data is generated.

A speaking control method in accordance with Aspect 15 of the present invention can further include in Aspects 12 through 14: a sound level determining step of determining the sound level of the target audio data, in a case where the sound level of the target audio data thus determined in the sound level determining step is less than the first sound-level threshold value, answer data indicative of content that prompts a conversation is transmitted with a predetermined chance in the transmitting step.

A speaking control method in accordance with Aspect 16 of the present invention can further include in Aspects 12 through 15: a sound level determining step of determining the sound level of the target audio data; and a recognition accuracy determining step of determining recognition accuracy indicative of accuracy of a recognizing process in which audio data content indicated by the target audio data is recognized as recognition content, in a case where (i) the sound level thus determined in the sound level determining step falls within the sound-level range and (ii) the recognition accuracy is a first accuracy threshold value or greater, at least one answer data associated with the recognition content is transmitted in the transmitting step.

The speaking control method in accordance with Aspect 17 of the present invention can be configured in Aspect 16 such that in a case where (i) the sound level of the target audio data thus determined in the sound level determining step falls within the sound-level range and (ii) the recognition accuracy falls within an accuracy range between a second accuracy threshold value or greater and less than the first accuracy threshold value, answer data, in the transmitting step, is (a) selected from a second database containing second answer data differing in category from first answer data contained in a first database which is referred to in the case where the recognition accuracy is the first accuracy threshold value or greater and (b) transmitted.

The speaking control method in accordance with Aspect 18 of the present invention can be configured in Aspect 17 such that the second answer data is randomly selected from the second database in the transmitting step.

The speaking control method in accordance with Aspect 19 of the present invention can be configured in Aspects 17 and 18 such that in a case where (i) the sound level of the target audio data determined in the sound level determining step falls within the sound-level range and (ii) the recognition accuracy is less than the second accuracy threshold value, no answer data with respect to audio data content indicated by the target audio data is transmitted in the transmitting step.

A server (servers 20 through 23) in accordance with Aspect 20 of the present invention includes: an answer transmitting section (reply control section 225) configured to transmit, in a case where a sound level of target audio data falls within a sound-level range between a first sound-level threshold value or greater and a second sound-level threshold value or less, answer data with respect to audio data content indicated by the target audio data.

According to the configuration, in a case where the sound level of the target audio data falls within the sound-level range between the first sound-level threshold value or greater and the second sound-level threshold value or less, the answer transmitting section transmits an answer in response to the audio data content indicated by the target audio data is transmitted. In other words, in a case where the sound level of the target audio data exceeds or falls below the sound-level range, the answer transmitting section transmits no answer data. This allows the server to prevent answer data with respect to the target audio data from being transmitted with an inappropriate timing.

A speaking device (cleaner robots 11 through 13) in accordance with Aspect 21 of the present invention includes: a voice data extracting section (voice detecting section 121) configured to extract, from audio data obtained, voice data containing only a frequency band of a human voice; a voice data transmitting section (communication section 101) configured to transmit the voice data; and an answer outputting section (speaker 104) configured to output, in a case where answer data with respect to the voice data is received, a voice indicated by the answer data, the answer data being answer data selected in a case where a sound level of the voice data is greater than a first sound-level threshold value and less than a second sound-level threshold value which is greater than the first sound-level threshold value.

According to the configuration, in a case where the sound level of the target audio data falls within the sound-level range between the first sound-level threshold value or greater and the second sound-level threshold value or less, the answer outputting section outputs an answer to audio data content indicated by the target audio data. In other words, in a case where the sound level of the target audio data exceeds or falls below the sound-level range, the answer outputting section outputs no sound indicated by answer data. This allows the speaking device to prevent answer data with respect to the target audio data from being transmitted with an inappropriate timing.

A speaking system (speaking systems 2 through 4) in accordance with Aspect 22 of the present invention includes: a speaking device (cleaner robots 11 through 13); and a server (server 21 through 23), said speaking device including a voice data extracting section (voice detecting section 121) configured to extract, from audio data obtained, voice data containing only a frequency band of a human voice, a voice data transmitting section (communication section 101) configured to transmit the voice data, and an answer outputting section (speaker 104) configured to output, in a case where the answer outputting section receives answer data with respect to the voice data, a voice indicated by the answer data, said server including a sound level determining section (sound level determining section 222) configured to determine a sound level of target voice data, and an answer transmitting section (reply control section 225) configured to transmit, in a case where the sound level of the voice data determined by the sound level determining section falls within a sound-level range between a first sound-level threshold value or greater and a second sound-level threshold value or less, answer data with respect to voice data content indicated by the voice data.

According to the configuration, in a case where the sound level of the target audio data falls within the sound-level range between the first sound-level threshold value or greater and the second sound-level threshold value or less, the answer transmitting section transmits an answer to audio data content indicated by the target audio data. In other words, in a case where the sound level of the target audio data exceeds or falls below the sound-level range, the answer transmitting section transmits no answer data. This allows the speaking system to prevent answer data with respect to the target audio data from being transmitted with an inappropriate timing.

The servers (servers 20 through 23) and the speaking devices (cleaner robots 10 through 14) of the aspects of the present invention can be realized by use of a computer. In this case, the scope of the present invention also encompasses a program for realizing each of the servers with the use of a computer by causing the computer to serve as each of the sections included in the server.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### INDUSTRIAL APPLICABILITY

The present invention is suitable for (i) home electrical appliances equipped with an input/output function, such as cleaner robots refrigerators microwave ovens personal computers and television receiver and (ii) servers that control these home electrical appliances.

### REFERENCE SIGNS LIST

1 through 5 Speaking system
10 through 14 Cleaner robot (speaking device)
20 through 23 Server
101 Communication section (voice data transmitting section, answer data receiving section)
102, 102a, 102b, 102c, and 102d Control section
103 Microphone
104 Speaker (answer outputting section)
105 Cleaning section
106 Driving section
121 Voice detecting section (voice data extracting section)
122 Sound level determining section (sound level determining section)
123 Voice recognizing section (voice recognizing section)
124 Accuracy determining section
125 Reply control section (answer option switching section)
201 Communication section (voice data receiving section
202, 202a, 202b, and 202c Control section
203 Storage section
221 Voice detecting section (extracting section)
222 Sound level determining section (sound level determining section)
223 Voice recognizing section (recognition accuracy determining section)
224 Accuracy determining section (recognition accuracy determining section)
225 Reply control section (answer transmitting section, answer option switching section)
231 Normal reply database
232 Vague reply database
233 Prompting reply database

1. A speaking control method comprising:
a switching step of switching between answer options for an answer to a user in a case where a sound level of target audio data falls within a first predetermined sound-level range,
the answer options being associated with a case where audio data content indicated by the target audio data is recognized and a case where the audio data content is not recognized, respectively.

2. The speaking control method as set forth in claim 1, wherein
in the case where the audio data content is recognized, a database containing a phrase whose answer content with respect to the audio data content does not apply to one-to-one correspondence or to one-to-many correspondence is referred to in the switching step.

3. The speaking control method as set forth in claim 1, wherein
in the switching step, databases which are referred to in order to determine answer content in reply to the user are switched in accordance with recognition accuracy indicative of accuracy of a recognizing process in which the audio data content is recognized as recognition content.

4. The speaking control method as set forth in claim 3, wherein
in the switching step, a referring process is carried out in a case where the recognition accuracy falls within a first predetermined recognition accuracy range,
the referring process being associated with the case where the audio data content is recognized,
in the switching step, the referring process being carried out to refer to:
a database containing a phrase (i) whose answer content with respect to the recognition content applies to one-to-one correspondence or to one-to-many correspondence and (ii) which is relative to the recognition content; or
a database containing a phrase whose answer content with respect to the recognition content does not apply to one-to-one correspondence or to one-to-many correspondence.

5. The speaking control method as set forth in claim 3, wherein
in a case where the recognition accuracy (i) falls within a first predetermined recognition accuracy range and (ii) falls within a second predetermined recognition accuracy range falling within part of the first predetermined recognition accuracy range which part shows relatively high recognition accuracy, a referring process is carried out in the switching step,
the referring process being associated with the case where the audio data content is recognized,
in the switching step, the referring process being carried out to refer to a database containing a phrase (i) whose answer content with respect to the recognition content applies to one-to-one correspondence or to one-to-many correspondence and (ii) which is relative to the recognition content.

6. The speaking control method as set forth in claim 2, wherein
in the switching step, answer data indicative of answer content in reply to the user is randomly selected from the database.

7. The speaking control method as set forth in claim 1, wherein
in a case where the sound level of the target audio data falls within a second predetermined sound-level range which is lower than the first predetermined sound-level range, one of the following is selected as an answer option in reply to the user in the switching step:
not answering the user; and
answering the user so as to prompt a conversation.

8. A server comprising:
an answer option switching section configured to switch between answer options for an answer to a user in a case where a sound level of target audio data falls within a first predetermined sound-level range,
the answer options being associated with a case where audio data content indicated by the target audio data is recognized and a case where the audio data content is not recognized, respectively.

9. A speaking device comprising:
a voice data extracting section configured to extract, from audio data obtained, voice data containing only a frequency band of a human voice;
a sound level determining section configured to determine a sound level of the voice data;
a voice recognizing section configured to recognize, in a case where the sound level thus determined by the sound level determining section falls within a predetermined sound-level range, voice data content as recognition content, which voice data content is indicated by the voice data;
an answer option switching section configured to (i) switch between answer options for an answer to a user, the answer options being associated with a case where voice data content indicated by the voice data is recognized and a case where the voice data content is not recognized, respectively and (ii) determine answer content; and
an answer outputting section configured to output a voice indicative of the answer content thus determined by the answer option switching section.

10. A computer-readable non-transitory storage medium in which a program for causing a computer to serve as a speaking device recited in claim 9 is stored, the program causing a computer to serve as each of the sections of the speaking device.

11. A speaking system comprising:
a speaking device; and
a server,
said speaking device including
a voice data extracting section configured to extract, from audio data obtained, voice data containing only a frequency band of a human voice,
a voice data transmitting section configured to transmit the voice data,
an answer data receiving section configured to receive answer data with respect to the voice data, and
an answer outputting section configured to output, in a case where the answer data receiving section receives the answer data, a voice indicated by the answer data,
said server including
a voice data receiving section configured to receive the voice data from the speaking device,
a sound level determining section configured to determine a sound level of the voice data thus received by the voice data receiving section,
an answer option switching section configured to (i) switch between answer options for an answer to a user in a case where the sound level of the voice data thus determined falls within a predetermined sound-level range, the answer options being associated with a case where voice data content indicated by the voice data is recognized and a case where the voice data content is not recognized, respectively and (ii) determine answer content, and
an answer transmitting section configured to transmit answer data indicative of the answer content thus determined by the answer option switching section.

12. A speaking device comprising:
a voice data extracting section configured to extract, from audio data obtained, voice data containing only a frequency band of a human voice;
a voice data transmitting section configured to transmit the voice data;
an answer data receiving section configured to receive answer data with respect to the voice data; and
an answer outputting section configured to output, in a case where the answer data receiving section receives the answer data, a voice indicated by the answer data,
the answer data being answer data indicative of answer content determined by switching between answer options for an answer to a user in a case where a sound level of the voice data transmitted by the voice data transmitting section falls within a predetermined sound-level range, the answer options being associated with a case where voice data content indicated by the voice data is recognized and a case where the voice data content is not recognized, respectively.
